(19) United States
(12) Patent Application Publication
(10) Pub. No.: US 2024/0428088 A1
(43) Pub. Date: Dec. 26, 2024

(54) MACHINE LEARNING USING MAP REPRESENTATIONS OF CATEGORICAL DATA TO PROVIDE CLASSIFICATION PREDICTIONS

(71) Applicant: Optum Services (Ireland) Limited, Dublin (IE)

(72) Inventors: Ahmed Selim, Dublin (IE); Paul J. Godden, London (GB); Melanie McCarney, Minneapolis, MN (US); Gregory J. Boss, Saginaw, MI (US); Erin A. Satterwhite, West Lakeland, MN (US); Nancy J. Mendelsohn, Mendota Heights, MN (US); Michael Bridges, Dublin (IE)

(21) Appl. No.: 18/338,043

(22) Filed: Jun. 20, 2023

(51) Int. Cl. G06N 5/022

(52) U.S. Cl. CPC G06N 5/022

(57) ABSTRACT

Various embodiments of the present disclosure provide machine learning using map representations of categorical data to provide classification predictions. In one example, an embodiment provides for generating a first map representation of a first categorical input feature set for categorical data based on a first coding standard. A second map representation of a second categorical input feature set for the categorical data may also be generated based on a second coding standard. Additionally, at least one machine learning model may be applied to the first map representation and the second map representation to generate the prediction output. Based on the prediction output one or more prediction-based actions may also be performed.

### BACKGROUND

Various embodiments of the present disclosure address technical challenges related to performing predictive data analysis in a computationally efficient and predictively reliable manner. Existing predictive data analysis systems are ill-suited to accurately, efficiently, and/or reliably perform predictive data analysis in various domains, such as domains that are associated with high-dimensional categorical feature spaces with a high degree of cardinality.

### BRIEF SUMMARY

In general, various embodiments of the present disclosure provide methods, apparatus, systems, computing devices, computing entities, and/or the like for providing machine learning using map representations of categorical data to provide classification predictions. To do so, at least a first map representation of a first categorical input feature set for categorical data may be generated based on a first coding standard. Additionally, at least a second map representation of a second categorical input feature set for the categorical data may be generated based on a second coding standard. The first map representation may map presence of one or more first predictive codes for the first coding standard in the categorical data. The second map representation may map presence of one or more second predictive codes for the second coding standard in the categorical data. Using at least one machine learning model, a prediction output based on the first map representation and the second map representation. Furthermore, the performance of one or more prediction-based actions may be initiated based on the prediction output.

In some embodiments, a computer-implemented method includes generating, by one or more processors, at least a first map representation of a first categorical input feature set for categorical data based on a first coding standard. In some embodiments, the first map representation maps presence of one or more first predictive codes for the first coding standard in the categorical data. In some embodiments, the computer-implemented method additionally or alternatively includes generating, by the one or more processors, at least a second map representation of a second categorical input feature set for the categorical data based on a second coding standard. In some embodiments, the second map representation maps presence of one or more second predictive codes for the second coding standard in the categorical data. In some embodiments, the computer-implemented method additionally or alternatively includes generating, by the one or more processors and using at least one machine learning model, a prediction output based on the first map representation and the second map representation. In some embodiments, the computer-implemented method additionally or alternatively includes initiating, by the one or more processors, the performance of one or more prediction-based actions based on the prediction output.

In some embodiments, a computing apparatus includes a memory and one or more processors communicatively coupled to the memory. In some embodiments, the one or more processors are configured to generate at least a first map representation of a first categorical input feature set for categorical data based on a first coding standard. In some embodiments, the first map representation maps presence of one or more first predictive codes for the first coding standard in the categorical data. In some embodiments, the one or more processors are additionally or alternatively configured to generate at least a second map representation of a second categorical input feature set for the categorical data based on a second coding standard. In some embodiments, the second map representation maps presence of one or more second predictive codes for the second coding standard in the categorical data. In some embodiments, the one or more processors are additionally or alternatively configured to generate, using at least one machine learning model, a prediction output based on the first map representation and the second map representation. In some embodiments, the one or more processors are additionally or alternatively configured to initiate the performance of one or more prediction-based actions based on the prediction output.

In some embodiments, one or more non-transitory computer-readable storage media include instructions that, when executed by one or more processors, cause the one or more processors to generate at least a first map representation of a first categorical input feature set for categorical data based on a first coding standard. In some embodiments, the first map representation maps presence of one or more first predictive codes for the first coding standard in the categorical data. In some embodiments, the instructions, when executed by the one or more processors, additionally or alternatively cause the one or more processors to generate at least a second map representation of a second categorical input feature set for the categorical data based on a second coding standard. In some embodiments, the second map representation maps presence of one or more second predictive codes for the second coding standard in the categorical data. In some embodiments, the instructions, when executed by the one or more processors, additionally or alternatively cause the one or more processors to generate, using at least one machine learning model, a prediction output based on the first map representation and the second map representation. In some embodiments, the instructions, when executed by the one or more processors, additionally or alternatively cause the one or more processors to initiate the performance of one or more prediction-based actions based on the prediction output.

### BRIEF DESCRIPTION OF THE DRAWINGS

FIG. 1 provides an example overview of an architecture in accordance with one or more embodiments of the present disclosure.

FIG. 2 provides an example classification prediction machine learning computing entity in accordance with one or more embodiments of the present disclosure.

FIG. 3 provides an example external computing entity in accordance with one or more embodiments of the present disclosure.

FIG. 4 provides an example system that provides machine learning associated with a data analytics engine in accordance with one or more embodiments of the present disclosure.

FIG. 5 provides an example first map representation in accordance with one or more embodiments of the present disclosure.

FIG. 6 provides another example first map representation in accordance with one or more embodiments of the present disclosure.

FIG. 7 provides another example system that provides machine learning associated with a data analytics engine in accordance with one or more embodiments of the present disclosure.

FIG. 8 provides an example system that provides for prediction-based actions and/or visualizations in accordance with one or more embodiments of the present disclosure.

FIG. 9 provides an example user interface related to prediction-based visualizations in accordance with one or more embodiments of the present disclosure.

FIG. 10 is a flowchart diagram of an example process for generating a prediction output for categorical data using map representations of the categorical data in accordance with one or more embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

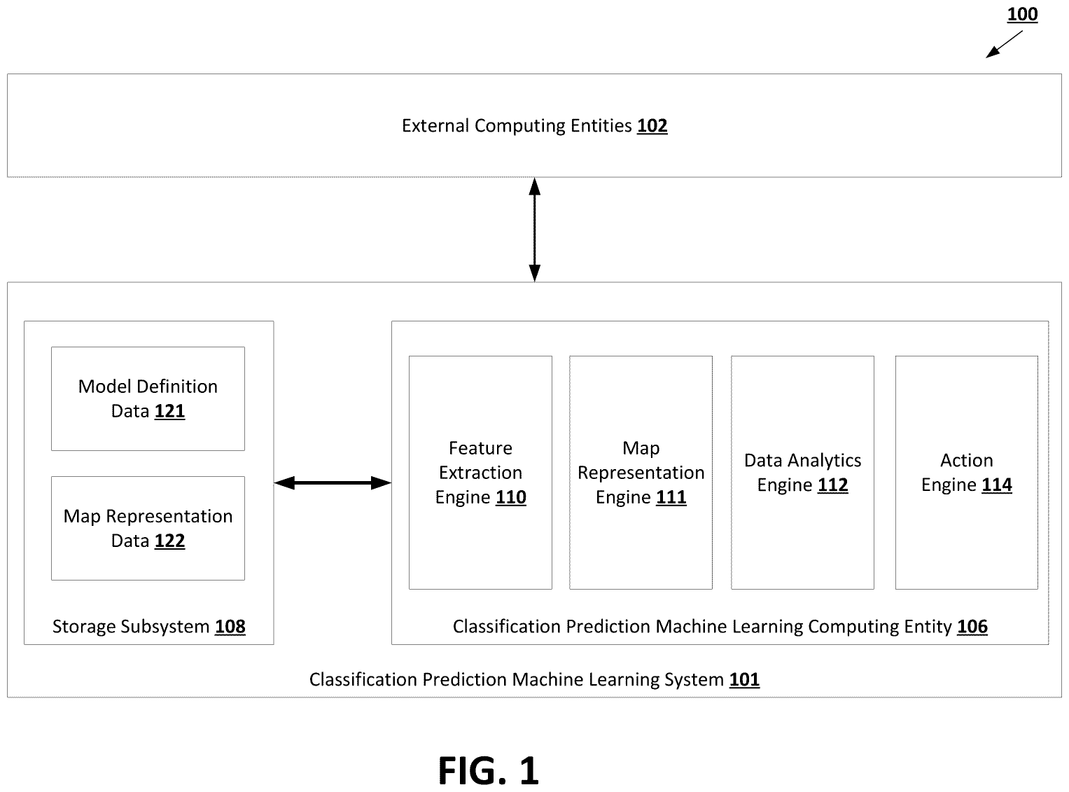

FIG. 1 provides an example overview of an architecture 100 that can be used to practice embodiments of the present disclosure. The architecture 100 includes a classification prediction machine learning system 101 and one or more external computing entities 102. For example, at least some of the one or more external computing entities 102 can provide inputs to the classification prediction machine learning system 101. Additionally or alternatively, at least some of the one or more external computing entities 102 can receive decision outputs, task outputs and/or action outputs from the classification prediction machine learning system 101 in response to providing the inputs. As another example, at least some of the external computing entities 102 can provide one or more data streams and/or one or more batch loads to the classification prediction machine learning system 101 and request performance of particular prediction-based actions in accordance with the provided one or more data streams and/or one or more batch loads. As a further example, at least some of the external computing entities 102 can provide training data to the classification prediction machine learning system 101 and request training of one or more machine learning models in accordance with the provided training data. In some of the noted embodiments, the classification prediction machine learning system 101 can be configured to transmit parameters, hyper-parameters, and/or weights of a trained machine learning model to the external computing entities 102.

In some embodiments, the classification prediction machine learning system 101 can include a classification prediction machine learning computing entity 106. The classification prediction machine learning computing entity 106 and the external computing entities 102 can be configured to communicate over a communication network (not shown). The communication network can include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

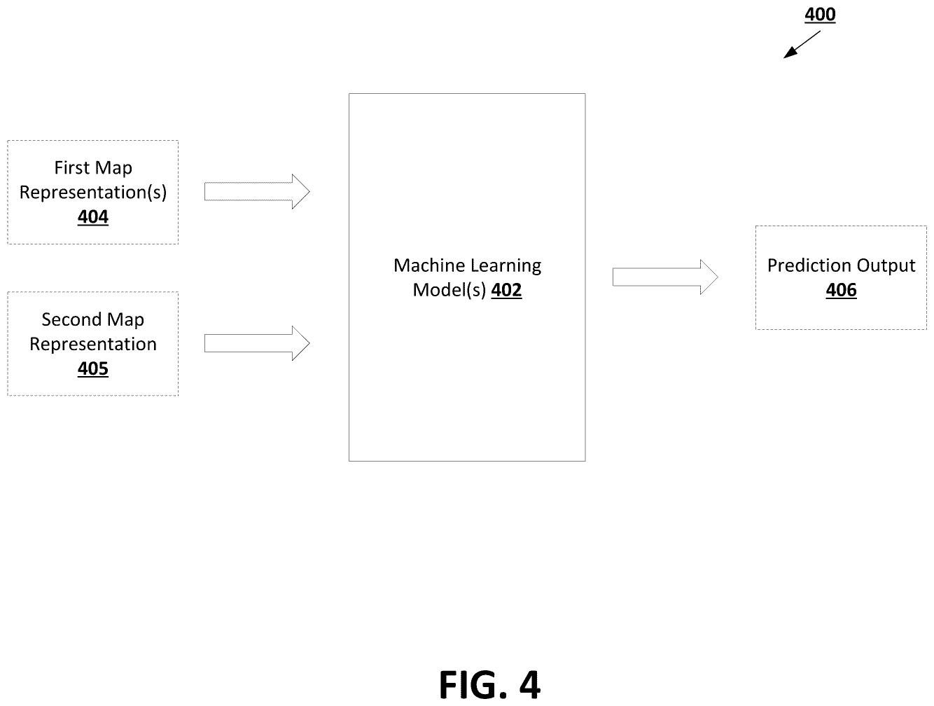

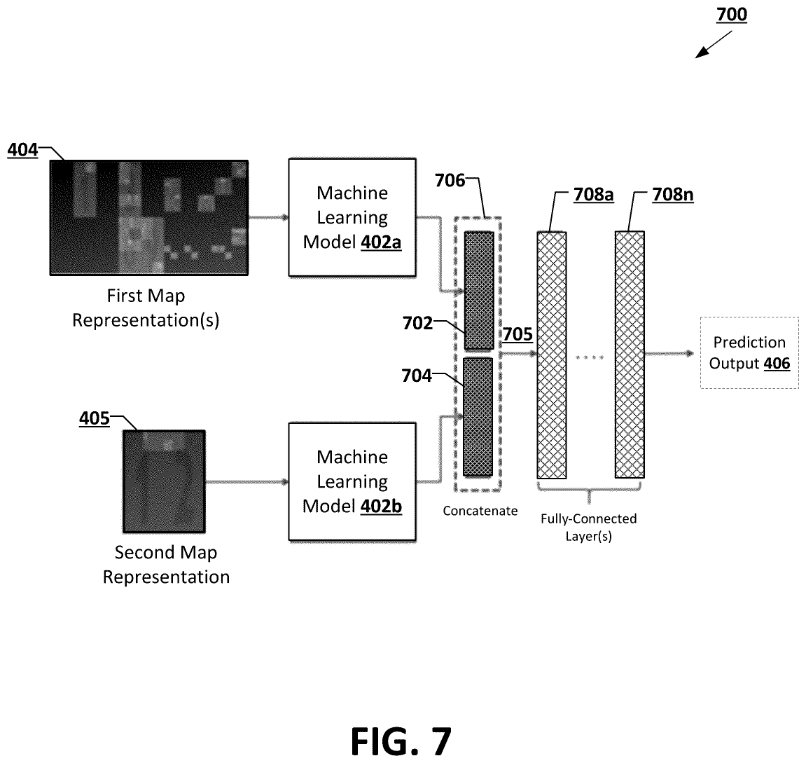

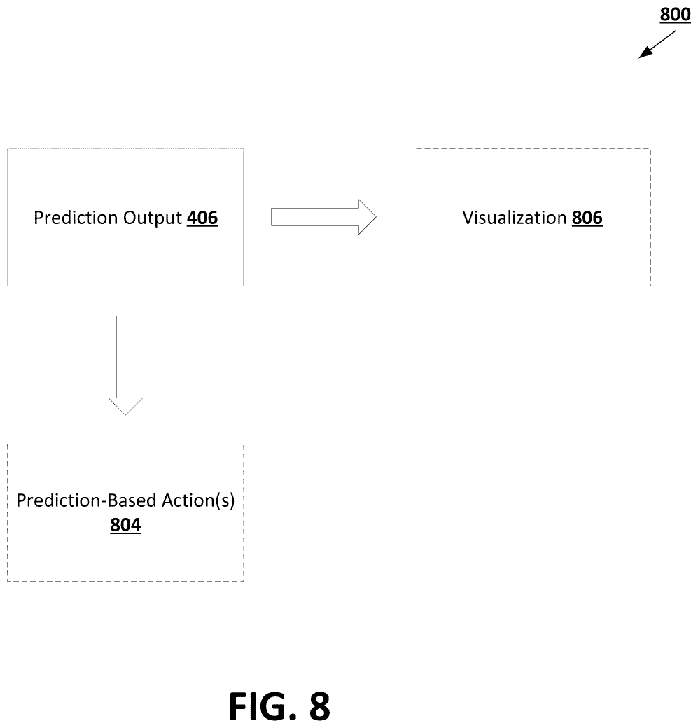

Additionally, in some embodiments, the classification prediction machine learning system 101 can include a storage subsystem 108. The classification prediction machine learning computing entity 106 can be configured to provide one or more predictions using one or more artificial intelligence techniques and/or one or more machine learning techniques. For instance, the classification prediction machine learning computing entity 106 can be configured to determine forecasts, insights, predictions, and/or classifications related to data from disparate database systems. The classification prediction machine learning computing entity 106 can be additionally or alternatively configured to compute optimal decisions, display optimal data for a dashboard (e.g., a graphical user interface), generate optimal data for reports, optimize actions, and/or optimize configurations associated with a decision management system, a workflow management system, a clinical decision automation system, a medical claim adjudication system, a clinical review system, and/or another type of system. The classification prediction machine learning computing entity 106 includes a feature extraction engine 110, a map representation engine 111, a data analytics engine 112, and/or an action engine 114. In some embodiments, the feature extraction engine 110 can perform feature extractions associated with categorical data to determine a categorical input feature set for the categorical data. In certain embodiments, the categorical data can comprise one or more document segments of one or more input document data objects. In some embodiments, the one or more document segments can be associated with a set of embeddings (e.g., a set of document embeddings and/or a set of code embeddings). An input document data object can be, for example, a medical record for a claim. A document segment can be, for example, a segment of a medical record that is deemed to be related to a predictive code for a claim line. In some embodiments, the map representation engine 111 can generate a map representation based on a categorical input feature set determined by the feature extraction engine 110. In some embodiments, the data analytics engine 112 can determine one or more predictions and/or classifications based on model definition data 121 and/or map representation data 122. The map representation data 122 can comprise one or more map representations generated by the map representation engine 111. The action engine 114 can employ the one or more predictions and/or classifications associated with the data analytics engine 112 to perform one or more actions. In certain embodiments, the action engine 114 can employ the one or more predictions and/or classifications associated with the data analytics engine 112 to provide one or more visualizations via user interface of a display (e.g., display 316). In certain embodiments, the action engine 114 can employ the one or more predictions and/or classifications associated with the data analytics engine 112 to optimize one or more machine learning models employed by the data analytics engine 112. As such, the classification prediction machine learning computing entity 106 can provide accurate, efficient and/or reliable predictions and/or classifications using machine learning. Further example operations of the data analytics engine 112, and/or the action engine 114 are described with reference to at least FIG. 4, FIG. 7 and FIG. 8.

In one or more embodiments, the model definition data 121 and/or the map representation data 122 can be stored in the storage subsystem 108. The storage subsystem 108 can include one or more storage units, such as multiple distributed storage units that are connected through a computer network. In certain embodiments, the model definition data 121 and/or the map representation data 122 can be stored in disparate storage units (e.g., disparate databases) of the storage subsystem 108. Each storage unit in the storage subsystem 108 can store at least one of one or more data assets and/or one or more data about the computed properties of one or more data assets. Moreover, each storage unit in the storage subsystem 108 can include one or more non-volatile storage or memory media including but not limited to hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

Various embodiments provide technical solutions to technical problems corresponding to predictive data analysis. In particular, predictive data analysis techniques related to sparce data and/or data stored in disparate data sources tend to be difficult, resource intensive, and/or inaccurate. For example, training of a machine learning model based on sparce data generally results in inaccurate predictions. Additionally, extensive querying of databases as a result of sparce data for training a machine learning model generally involves inefficient usage of computational resources. However, with the architecture 100 and one or more other embodiments disclosed herein, one or more technical improvements can be provided such as improved accuracy and a reduction in computationally intensiveness and time intensiveness needed for automated managing, ingesting, monitoring, updating, and/or extracting/retrieving of data for providing predictions using machine learning. With the architecture 100 and one or more other embodiments disclosed herein, reduction in computational resources required for automated managing, ingesting, monitoring, updating, and/or extracting/retrieving of data for providing prediction using machine learning can also be provided. The architecture 100 can also allocate processing resources, memory resources, and/or other computational resources to other tasks while executing one or more processes related to providing prediction using machine learning in parallel. As such, various embodiments of the present disclosure therefore provide improvements to the technical field of processing and/or analyzing sparce data from disparate network systems. In certain embodiments, a graphical user interface of a computing device that renders at least a portion of predictions, classifications, and/or insights can also be improved by optimally presenting visual data related to the predictions, classifications, and/or insights.

### III. EXAMPLES OF CERTAIN TERMS

The term “event” may refer to may refer to an electronically-maintained data construct that is configured to describe one or more categorical input features pertaining to a recorded event, such as one or more clinical codes associated with a medical visit event by a user. In some embodiments, an event may describe a clinical event. For example, an event may describe a healthcare visit, a diagnosis for a user during a healthcare visit, a pharmaceutical purchase visit, or the like. In some embodiments, each event may be associated with a date data object indicative of when the event occurred.

The term “categorical data” may refer to an electronically-maintained data construct that is configured to describe data pertaining to one or more data sources and/or one or more events. In some embodiments, the categorical data may refer to one or more portions of one or more medical records and/or medical data. In some embodiments, the categorical data may include a plurality of predictive codes, a plurality of character patterns for a plurality of character pattern positions, and/or data associated therewith.

The term “character pattern position” may refer to an electronically managed data construct that is configured to describe a particular set of characters in the categorical input features having a particular categorical input feature type, where the particular set of characters are defined by a position of the particular set of characters within the categorical input features having the particular categorical input feature type. For example, given the categorical input features having a predictive code categorical input feature type, the first character of a predictive code may have a first character pattern position, a second character of a predictive code may have a second character pattern position and so on. Accordingly, given a predictive code “A53,” an associated first character pattern position may comprise the character pattern corresponding to the first digit (e.g., “A”), the second character pattern position may comprise the character pattern corresponding to the second digit (e.g., “5”), and the third character position may comprise the character pattern corresponding to the third digit (e.g., “3”). In some embodiments, each character pattern position for a group of categorical input features having a particular categorical input feature type may be associated with a set of candidate character patterns. For example, for the first character position of a predictive code, the plurality of candidate character patterns may include “A,” “B,” “C,” or “D,” while, for each of the second character position and third character positions for a predictive code, the plurality of candidate character patterns may include a number between 1 to 9.

The term “prediction output” may refer to a data construct that describes one or more prediction insights, classifications, and/or inferences provided by one or more machine learning models. In various embodiments, prediction insights, classifications, and/or inferences may be with respect to one or more data objects and/or features of one or more groupings of text, such as, one or more portions of a document. In certain embodiments, a prediction output can provide a prediction as to whether medical records for a patient indicates that a patient is associated with a particular type of disease, such as, a particular type of rare disease.

The term “input document data object” may refer to a data construct that describes a collection of text data. For example, in certain embodiments, an input document data object may correspond to a medical record. A medical record (e.g., typically multiple pages) may contain information for all claim lines in a case. A portion of a medical record for a particular claim line may be one paragraph or a set of keywords in the medical record.

The term “prediction input data object” may refer to a data construct that describes a real world entity and/or a virtual entity with respect to which one or more predictive data analysis operations are performed. An example of a prediction input data object is a medical/health insurance claim. In various embodiments, a prediction input data object may be associated with a set of C predictive codes and/or an input document data object having a set of C document segments. In various embodiments, each document segment may be associated with a respective one of the C predictive codes, such that there is a one-to-one relationship between the set of predictive codes and the set of document segments. In certain embodiments, a prediction input data object may refer to a claim of a medical record.

The term “predictive code” may refer to a data construct that describes an identifier for one or more tasks, one or more services, and/or one or more actions related to the input segment. In certain embodiments, a predictive code may be a medical code employed to report one or more tasks, one or more services, and/or one or more actions related to a medical record. For example, in certain embodiments, a predictive code may be a CPT code, a DX code, an RX code, a Logical Observation Identifier Names and Codes (LOINC) code, or another type of predictive code. In certain embodiments, a predictive code may be selected from a set of predictive codes stored in a data structure.

The term “document segment” may refer to a data construct that describes a segment of an input document data object that is deemed related to a predictive code. For example, in certain embodiments, a document segment may correspond to a segment of a medical record that is deemed related to CPT code, a DX code, an RX code, a LONIC code, or another type of predictive code for a claim line.

The term “machine learning framework” may refer to a data construct that describes parameters, hyperparameters, and/or defined operations of one or more machine learning models configured to generate a prediction output for a prediction input data object. In some embodiments, the machine learning framework process one or more input segments, one or more document segments, one or more predictive codes, categorical data, map representations, and/or other data related to one or more input document data objects. A machine learning framework may be configured to provide a prediction for one or more input segments, one or more document segments, one or more predictive codes, categorical data, map representations, and/or other data related to one or more input document data objects via respective attributes and/or features for one or more map representations applied to the one or more machine learning techniques.

A “prediction score” may refer to a data construct that describes a particular prediction described by a prediction output for a respective input segment of the prediction input data object. In some embodiments, the prediction score for an input segment is a score that corresponds to a probability for a particular insight, classification, and/or inference provided by the segment-wise prediction machine learning framework. For example, in certain embodiments, a prediction score may correspond to a diagnosis probability for a particular type of disease, such as, a particular type of rare disease.

A “machine learning model” may refer to a data construct that describes parameters, hyperparameters, and/or defined operations configured to generate a prediction output using machine learning techniques. In certain embodiments, a machine learning model is trained based on ground-truth outputs (e.g., ground-truth code classifications and/or the like) for a set of training data. In certain embodiments, a machine learning model may be configured as a neural network model, a deep learning model, a convolutional neural network (CNN) model, and/or another type of machine learning model configured for predictions, classifications, and/or inferences related to disease diagnosis.

A “map representation” may refer to a vector representation (e.g., 1-D vector representation), an image (e.g., a visual embedding), a video (e.g., a video embedding), audio (e.g., an audio embedding), text, and/or another type of data representation that allocates respective portions of the map representation to a respective predictive code. Additionally, a respective portion of a map representation for a respective predictive code may be uniquely configured based on attributes of the respective predictive code as identified in categorical data. For example, one or more pixels assigned to a respective predictive code in a map representation configured as a visual embedding may be visually modified based on presence of the predictive code in the categorical data, a number of occurrences of the predictive code in categorical data, a predicted cost associated services, procedures, and/or events associated with the predictive code in the categorical data, and/or one or more other attributes of the predictive code with respect to data identified in the categorical data.

A “coding standard” may refer to an encoding or data classification standard as provided by a coding classification system, such as, a medical coding classification system.

A “categorical input feature set” may refer to a set of attributes associated with categorical data. A categorical input feature set may be related to one or more coding standards, one or more predictive codes, a user identifier, one or more entity identifiers, and/or other criteria. In some embodiments, a classical input feature set may be configured as a feature vector.

### IV. OVERVIEW, TECHNICAL IMPROVEMENTS, AND TECHNICAL ADVANTAGES

The present disclosure addresses technical challenges related to performing predictive data analysis in a computationally efficient and predictively reliable manner. Existing predictive data analysis systems are generally ill-suited to accurately, efficiently, and/or reliably perform predictive data analysis in various domains, such as domains that are associated with high-dimensional categorical feature spaces with a high degree of cardinality.

Discussed herein are methods, apparatus, systems, computing devices, computing entities, and/or the like for analysis of digital data using machine learning. Certain embodiments utilize methods, apparatus, systems, computing devices, computing entities, and/or the like for additionally performing actions based on the analysis of the digital data and/or predictions associated therewith. In various embodiments, methods, apparatus, systems, computing devices, computing entities, and/or the like that provide machine learning using map representations of categorical data. The machine learning using map representations of categorical data can provide classification prediction, such as, diagnostic predictions or other predictions related to the categorical data. As will be recognized, the disclosed concepts can be used to perform any type of artificial intelligence for predictions related to categorical data. Examples of artificial intelligence include, but are not limited to, machine learning, linear regression modeling, supervised machine learning (e.g., classification analysis, regression analysis, etc.), unsupervised machine learning (e.g., clustering analysis, etc.), deep learning, neural network architectures, and/or the like.

Healthcare organizations often employ information from disparate database systems to facilitate providing one or more products and/or one or more services. However, it is generally difficult to accurately, efficiently, and/or reliably provide insights and forecasts related to data from disparate database systems. Moreover, it is generally especially difficult to accurately, efficiently, and/or reliably provide insights and forecasts related to certain types of diseases such as rare diseases that affect, for example, one patient in a million or the like. For example, a physician with frequent patient contact may never or rarely treat a patient with certain types of diseases such as a particular type of rare disease. As such, correctly diagnosing patients with these certain types of diseases can be difficult. Moreover, it is generally difficult to train and/or construct a machine learning model to identify patients with certain types of diseases such as a rare disease due to the nature of scarce data available for these certain types of diseases. Accordingly, data insights associated with certain types of diseases is generally a difficult process due to the lack of data generally available for such certain types of diseases.

Additionally, many existing predictive data analysis solutions for data insights are incapable of efficiently and/or reliably performing predictive data analysis in prediction domains with scarce input spaces. This is because many existing predictive data analysis solutions are developed for more common predictive data analysis tasks like image classification. For example, in the image classification domain, neural networks can be utilized to perform predictive data analysis. Such solutions, however, are largely out of reach of developers in prediction domains with scarce input structures, such as prediction domains with scarce categorical feature spaces, prediction domains with highly sparse data, and/or prediction domains with high cardinality data. Thus, there is a technical need for predictive data analysis solutions that are capable of efficiently and reliably performing predictive data analysis in prediction domains with sparce input spaces.

Additionally, difficulties with existing predictive data analysis solutions are further exacerbated by the inability to communicate temporal information within existing input structures. For example, in the image classification domain, the input structure may be configured in a variety of ways but nevertheless lacks communication of any associated temporal aspect. In some instances, such as detecting or monitoring certain types of diseases such as rare diseases of a patient, it may be beneficial to communicate such temporal aspects to detect patterns within a plurality of input structures to determine how such patterns evolve over time.

Various embodiments of the present disclosure address technical challenges related to providing insights and/or forecasts related to data with a scarce amount of available data for efficiently and reliably performing predictive data analysis in prediction domains. In various embodiments, machine learning using map representations of categorical data is utilized to provide classification predictions, such as, diagnostic predictions. For example, a machine learning framework and/or related technical techniques can be provided to identify rare disease members. Additionally or alternatively, a machine learning framework and/or related technical techniques can be provided to utilize available data for both common and rare diseases in a specialized manner to overcome the limitation of having scarce data for rare diseases. In various embodiments, patient history data from different angles can be cumulatively analyzed (e.g., without considering time information or an order of medical events). The cumulative representations of the patient history data can also be provided to a data analytics engine (e.g., one or more machine learning models) to perform a prediction task (e.g., disease diagnostic detection, rare disease member identification, etc.). In various embodiments, clinical data and provider data can be transformed into respective cumulative history maps that provides a data representation for a coding standard without time information and/or an order of medical events. Additionally, one or more machine learning models can be applied to the respective cumulative history maps to provide a diagnosis prediction (e.g., a rare disease prediction) for a patient (e.g., a patient identifier) associated with medical records. In certain embodiments, a front-end visualization can also be provided for end-users to engage with a prediction task or another type of insight related to forecasted output, insights, predictions, and/or classifications.

In various embodiments, a cumulative clinical history map can be generated from cumulative clinical history data according to a coding standard without temporal signals. The coding standard associated with the cumulative clinical history map can include a diagnosis coding standard, a medication coding standard, a procedures coding standard, and/or another type of coding standard. In a non-limiting example, the coding standard can be an International Classification of Diseases Tenth Revision (ICD10) diagnosis (DX) code, an ICD10 medication (RX) code, an ICD10 current procedural terminology (CPT) code, and/or another type of code employed for medical records or medical claim reporting. In various embodiments, presence of each code can be indicated via the cumulative clinical history map. In various embodiments, a number of occurrences of each code can be indicated via the cumulative clinical history map. To further mitigate an effect of temporal signals in clinical/provider data, the cumulative clinical history map can also be configured based on cost (e.g., a number of occurrences of each code and/or a cost associated with each code). In various embodiments, the cumulative clinical history map can be configured as a vector representation (e.g., 1-D vector representation), an image (e.g., a visual embedding), a video (e.g., a video embedding), audio (e.g., an audio embedding), text, and/or another type of data representation. The cumulative clinical history map can also be configured for a defined period of time (e.g., 6 months, 1 year, 5 years, etc.). Accordingly, the cumulative clinical history map can be defined as a data representation for a coding standard in which respective codes included in the data for a patient can be presented along with a count and/or a cost of each code within a specific period of time.

A cumulative provider history map can additionally be generated from cumulative provider history data according to a coding standard without temporal signals. The coding standard associated with the cumulative provider history map can include a provider coding standard and/or another type of coding standard. In addition, one or more ML models can be applied to the cumulative clinical history map and the cumulative provider history map to provide a classification prediction, such as, a diagnostic prediction. In various embodiments, multiple cumulative provider history maps can be utilized to represent multiple classification levels. For example, a code can be related to a primary classification or a sub-classification. In various embodiments, presence of each code can be indicated via the cumulative provider history map. In various embodiments, a number of occurrences of each code can be indicated via the cumulative provider history map. To further mitigate an effect of temporal signals in clinical/provider data, the cumulative provider history map can also be configured based on cost (e.g., a number of occurrences of each code and/or a cost associated with each code). In various embodiments, the cumulative provider history map can be configured as a vector representation (e.g., 1-D vector representation), an image (e.g., a visual embedding), a video (e.g., a video embedding), audio (e.g., an audio embedding), text, and/or another type of data representation. The cumulative provider history map can also be configured for a defined period of time (e.g., 6 months, 1 year, 5 years, etc.). Accordingly, the cumulative provider history map can be defined as a data representation for a coding standard in which respective codes included in the data for a provider can be presented along with a count and/or a cost of each code within a specific period of time.

The machine learning framework provided herein by using map representations of categorical data to provide classification predictions can provide a machine learning model that is more efficient to train and/or more reliable after a trained version of the machine learning model is generated. In doing so, various embodiments of the present disclosure address shortcomings of existing predictive data analysis solutions and enable solutions that are capable of efficiently and reliably performing predictive data analysis in prediction domains with scarce input spaces as well as conveying temporal information.

The machine learning framework can also provide significant advantages over existing technological solutions, such as, improved integrability, reduced complexity, improved accuracy, and/or improved speed as compared to existing technological solutions for providing insights and/or forecasts related to data. Accordingly, by employing various techniques related to the machine learning framework disclosed herein, various embodiments of the present disclosure enable utilizing efficient and reliable machine learning solutions to process data feature spaces with a high degree of size, diversity and/or cardinality. In doing so, various embodiments of the present disclosure address shortcomings of existing system solutions and enable solutions that are capable of accurately, efficiently and/or reliably providing forecasts, insights, and classifications to facilitate optimal decisions and/or actions related to the health information. Moreover, by employing various techniques related to the machine learning framework disclosed herein, one or more other technical benefits can be provided, including improved interoperability, improved reasoning, reduced errors, improved information/data mining, improved analytics, and/or the like related to machine learning. Accordingly, the machine learning framework disclosed herein provides improved predictive accuracy without reducing training speed and also enable improving training speed given a constant predictive accuracy. In doing so, the techniques described herein can additionally or alternatively improve efficiency and speed of training machine learning models, thus reducing the number of computational operations needed and/or the amount of training data entries needed to train machine learning models. Accordingly, the techniques described herein improve at least one of the computational efficiency, storage-wise efficiency, and speed of training machine learning models.

### V. EXAMPLE SYSTEM OPERATIONS

To provide the significant advantages over existing technological solutions, such as, improved integrability, reduced complexity, improved accuracy, and/or improved speed as compared to existing technological solutions for providing insights and/or forecasts related to data. Accordingly, by employing various techniques related to the machine learning framework disclosed herein, various embodiments of the present disclosure enable utilizing efficient and reliable machine learning solutions to process data feature spaces with a high degree of size, diversity and/or cardinality. In doing so, various embodiments of the present disclosure address shortcomings of existing system solutions and enable solutions that are capable of accurately, efficiently and/or reliably providing forecasts, insights, and classifications to facilitate optimal decisions and/or actions related to the health information. Moreover, by employing various techniques related to the machine learning framework disclosed herein, one or more other technical benefits can be provided, including improved interoperability, improved reasoning, reduced errors, improved information/data mining, improved analytics, and/or the like related to machine learning. Accordingly, the machine learning framework disclosed herein provides improved predictive accuracy without reducing training speed and also enable improving training speed given a constant predictive accuracy. In doing so, the techniques described herein can additionally or alternatively improve efficiency and speed of training machine learning models, thus reducing the number of computational operations needed and/or the amount of training data entries needed to train machine learning models. Accordingly, the techniques described herein improve at least one of the computational efficiency, storage-wise efficiency, and speed of training machine learning models.

### Example Classification Prediction Machine Learning Computing Entity

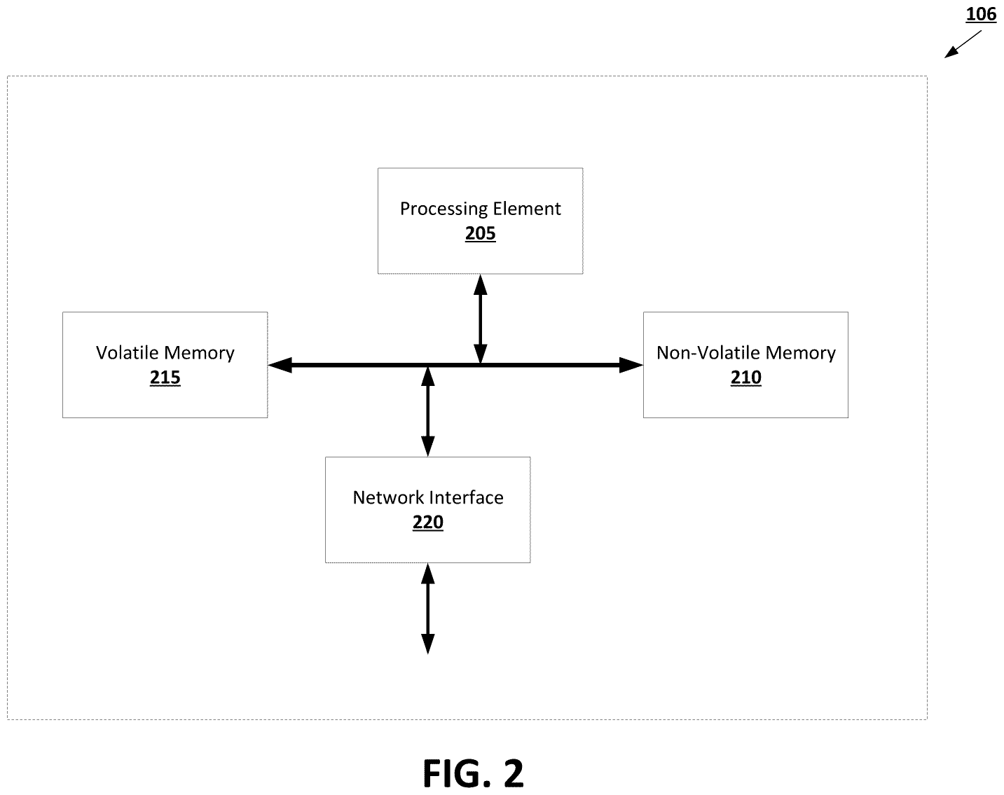

FIG. 2 provides a schematic of the classification prediction machine learning computing entity 106 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the classification prediction machine learning computing entity 106 may also include a network interface 220 for communicating with various computing entities, such as by communicating data, content, information, and/or similar terms used herein interchangeably that may be transmitted, received, operated on, processed, displayed, stored, and/or the like. Furthermore, it is to be appreciated that the network interface 220 may include one or more network interfaces.

As shown in FIG. 2, in one embodiment, the classification prediction machine learning computing entity 106 may include or be in communication with processing element 205 (also referred to as processors, processing circuitry, and/or similar terms used herein interchangeably) that communicate with other elements within the classification prediction machine learning computing entity 106 via a bus, for example. It is to be appreciated that the processing element 205 may include one or more processing elements. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the classification prediction machine learning computing entity 106 may further include or be in communication with non-volatile memory 210. The non-volatile memory 210 may be non-volatile media (also referred to as non-volatile storage, memory, memory storage, memory circuitry, and/or similar terms used herein interchangeably). Furthermore, in an embodiment, non-volatile memory 210 may include one or more non-volatile storage or memory media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the classification prediction machine learning computing entity 106 may further include or be in communication with volatile memory 215. The volatile memory 215 may be volatile media (also referred to as volatile storage, memory, memory storage, memory circuitry, and/or similar terms used herein interchangeably). Furthermore, in an embodiment, the volatile memory 215 may include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the classification prediction machine learning computing entity 106 with the assistance of the processing element 205 and operating system.

As indicated, in one embodiment, the classification prediction machine learning computing entity 106 may also include the network interface 220. In an embodiment, the network interface 220 may be one or more communications interfaces for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the classification prediction machine learning computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the classification prediction machine learning computing entity 106 may include or be in communication with one or more input elements, such as a keyboard input, a mouse input, a touch screen/display input, motion input, movement input, audio input, pointing device input, joystick input, keypad input, and/or the like. The classification prediction machine learning computing entity 106 may also include or be in communication with one or more output elements (not shown), such as audio output, video output, screen/display output, motion output, movement output, and/or the like.

### Example External Computing Entity

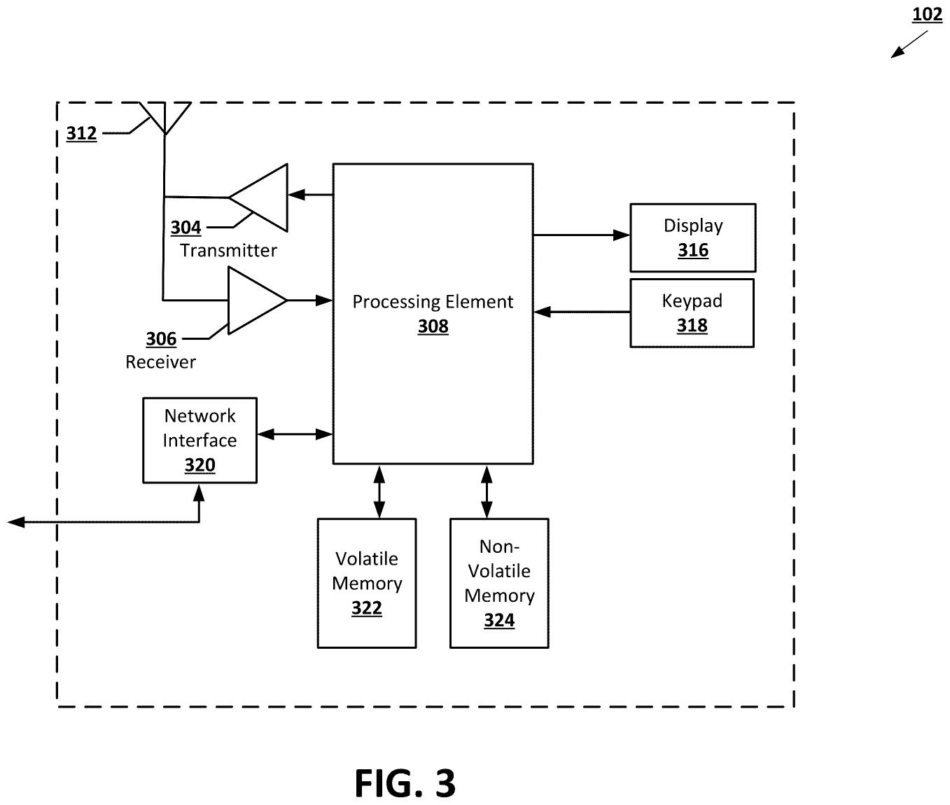

FIG. 3 provides an illustrative schematic representative of an external computing entity 102 that may be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The external computing entity 102 may be operated by various parties. As shown in FIG. 3, the external computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) which provide signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the classification prediction machine learning computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the classification prediction machine learning computing entity 106 via a network interface 320.

Via these communication standards and protocols, the external computing entity 102 may communicate with various other entities using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 may also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The external computing entity 102 may also comprise a user interface (that may include a display 316 coupled to the processing element 308) and/or a user input interface (coupled to the processing element 308). For example, the user interface may be a user application, browser, user interface, graphical user interface, dashboard, and/or similar words used herein interchangeably executing on and/or accessible via the external computing entity 102 to interact with and/or cause display of information/data from the classification prediction machine learning computing entity 106, as described herein. The user input interface may comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *) and other keys used for operating the external computing entity 102, and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The external computing entity 102 may also include volatile memory 322 and/or non-volatile memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile memory 322 and/or the non-volatile memory 324 may store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the classification prediction machine learning computing entity 106 and/or various other computing entities.

In another embodiment, the external computing entity 102 may include one or more components or functionalities that are the same or similar to those of the classification prediction machine learning computing entity 106, as described in greater detail above. As will be recognized, these architectures and descriptions are provided for example purposes only and are not limiting to the various embodiments.

In various embodiments, the external computing entity 102 may be embodied as an artificial intelligence (AI) computing entity, such as a virtual assistant AI device, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

As described below, various embodiments of the present disclosure introduce techniques that improve the training accuracy and/or speed of processing machine learning frameworks by introducing a machine learning framework architecture that generate a prediction output for categorical data using map representations of the categorical data. The combination of the noted components enables the proposed machine learning framework to generate more accurate predictions, which in turn increases the training speed of the proposed machine learning framework given a desired predictive accuracy. It is well-understood in the relevant art that there is typically a tradeoff between predictive accuracy and training speed, such that it is trivial to improve training speed by reducing predictive accuracy, and thus the real challenge is to improve training speed without sacrificing predictive accuracy through innovative model architectures. Accordingly, techniques that improve predictive accuracy without harming training speed, such as various techniques described herein, enable improving training speed given a constant predictive accuracy. Therefore, by improving accuracy of performing machine learning predictions using map representations of the categorical data, various embodiments of the present disclosure improve the training speed of machine learning frameworks given a target predictive accuracy.

In general, embodiments of the present disclosure provide methods, apparatus, systems, computing devices, computing entities, and/or the like for generating a prediction output for categorical data using map representations of the categorical data. Certain embodiments of the systems, methods, and computer program products that facilitate recommendation prediction and/or prediction-based actions employ one or more machine learning models and/or one or more machine learning techniques.

Various embodiments of the present disclosure address technical challenges related to accurately, efficiently, and/or reliably performing predictive data analysis of sparce data stored in disparate data sources. For example, in various embodiments, proposed solutions provide for modeling using machine learning with respect to map representations of the categorical data. In various embodiments, proposed solutions disclose classification predictions using machine learning. In some embodiments, one or more machine learning models to facilitate classification predictions may be trained and/or generated based on the model definition data 121 and/or the map representation data 122. After the one or more machine learning models are generated, the one or more machine learning models may be utilized to perform accurate, efficient, and reliable classification predictions.

### Machine Learning Techniques for Modeling Using Map Representations of Categorical Data

FIG. 4 illustrates an example system 400 related to one or more machine learning models associated with the data analytics engine 112, in accordance with one or more embodiments of the present disclosure. The system 400 includes one or more machine learning models 402. In one or more embodiments, the data analytics engine 112 may employ the one or more machine learning models 402 to generate prediction output 406. The one or more machine learning models 402 may be applied to one or more first map representations 404 and a second map representation 405 to generate the prediction output 406. In some embodiments, the one or more first map representations 404 may be one or more clinical map representations and the second map representation 405 may be a provider map representation. The one or more first map representations 404 and the second map representation 405 may be generated by the map representation engine 111. Additionally, in one more embodiments, the map representation data 122 may include the one or more first map representations 404 and the second map representation 405. The prediction output 406 may be, for example, a diagnostic prediction, insight, classification, and/or inference related to a certain types of disease such as a particular type of rare disease.

In one or more embodiments, the map representation engine 111 generates the one or more first map representations 404 based on one or more coding standards for a patient category. The one or more first map representations 404 may be respective map representations of a categorical input feature set for categorical data related to the patient category. For example, the one or more first map representations 404 may be respective cumulative clinical history maps for clinical patient data related to diagnoses, medications, procedures, and/or one or more other types of clinical patient data. The one or more coding standards may be a diagnosis coding standard (e.g., ICD10 DX), a medication coding standard (e.g., ICD10 RX), a procedures coding standard (e.g., ICD10 CPT), and/or another type of coding standard. The one or more first map representations 404 may map presence of one or more predictive codes for the coding standard in the categorical data. In one or more embodiments, the one or more first map representations 404 may map a number of occurrences in the categorical data for one or more predictive codes associated with the coding standard. Additionally or alternatively, the one or more first map representations 404 may map a predicted cost for the one or more predictive codes with respect to the number of occurrences related to the categorical data for the patient category.

In certain embodiments, the feature extraction engine 110 identifies a plurality of character patterns associated with a categorical input feature. In some embodiments, the feature extraction engine 110 may identify the plurality of character patterns based on the type of structured text input features described by the categorical input feature. For example, the categorical input feature may describe a type of structured text input feature, such as, a predictive code or the like. Each structure text input feature type may be associated with a plurality of character pattern positions and each character pattern position may be associated with a character pattern from one or more candidate character patterns.

A categorical input feature may describe a type of structure text input feature associated with three character pattern positions, wherein the first character pattern position may include the candidate character patterns “A,” “B,” “C,” or “D,” the second character pattern position may include the candidate character patterns “1,” “2,” “3,” “4,” “5,” “6,” “7,” “8,” or “9,” and the third character pattern position may include the candidate character patterns “1,” “2,” “3,” “4,” “5,” “6,” “7,” “8,” or “9.” As such, feature extraction engine 110 may process a categorical input feature described by the aforementioned type of structure text input feature, wherein the categorical input feature comprises the structure text input feature “A53.” The feature extraction engine 110 may identify the first character pattern position corresponds to a character pattern “A,” the second character pattern position corresponds to a character pattern “5,” and the third character pattern position corresponds to a character pattern “3.”

In one or more embodiments, the map representation engine 111 generates the second map representation 405 based on one or more coding standards for a provider category. The second map representation 405 may be a map representation of a categorical input feature set for categorical data related to the provider category. For example, the second map representation 405 may be a cumulative provider history map for clinical provider data related to provider taxonomy codes, provider classification levels, and/or provider areas of specialization. The second map representation 405 may map presence of one or more predictive codes associated with the coding standard in the categorical data. In one or more embodiments, the second map representation 405 may map a number of occurrences in the categorical data for one or more predictive codes associated with the coding standard. Additionally or alternatively, the second map representation 405 may map a predicted cost for the one or more predictive codes with respect to the number of occurrences related to the categorical data for the provider category.

In certain embodiments, to facilitate obtaining features for map representations, the feature extraction engine 110 may obtain a categorical input feature. Examples of a categorical input feature include structured text input features, including feature data associated with a predictive entity. For example, the categorical input feature may include feature data, such as medical feature data, associated with a particular patient predictive entity. As another example, the categorical input feature may include feature data, such as transactional feature data, associated with a medical facility predictive entity.

In one or more embodiments, the map representation engine 111 generates one or more map representations (e.g., the one or more first map representations 404 and/or the second map representation 405) based on the categorical input feature. In some embodiments, to generate the one or more image representations based on the categorical input feature, the feature extraction engine 110 retrieves configuration data for a particular image-based processing routine from the model definition data 121 stored in the storage subsystem 108. However, one of ordinary skill in the art will recognize that the map representation engine 111 may may generate one or more map representations by applying any suitable technique for transforming the categorical input feature into the one or more map representations. In some embodiments, the map representation engine 111 selects a suitable map-based processing routine for the categorical input feature given the one or more properties of the categorical input feature (e.g., size of the categorical input feature, a character pattern of the categorical input feature, and/or the like).

In various embodiments, the one or more first map representations 404 and/or the second map representation 405 may be configured without indicating temporal features of categorical data, such as, waiting times or durations between predictive codes in the categorical data. Additionally or alternatively, the one or more first map representations 404 and/or the second map representation 405 may be configured without indicating an order by which predictive codes appear in categorical data.

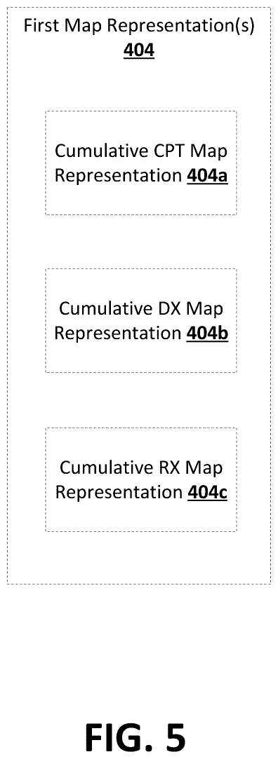

FIG. 5 illustrates an example first map representation 404, in accordance with one or more embodiments of the present disclosure. The first map representation 404 includes one or more clinical map representations, such as, a cumulative CPT map representation 404a, a cumulative DX map representation 404b, and/or a cumulative RX map representation 404c. The cumulative CPT map representation 404a may be a map representation that maps presence of one or more CPT codes in medical records, a number of occurrences of one or more CPT codes in medical records, and/or other data associated with categorical data for a patient category. The cumulative CPT map representation 404a may additionally or alternatively map a predicted cost for the one or more CPT codes with respect to presence and/or the number of occurrences for the one or more CPT codes. A CPT code may refer to a data construct that describes an identifier for one or more tasks, one or more procedures, one or more services, and/or one or more actions performed by a provider for a patient related to a patient category. In certain embodiments, a CPT code may be a medical code employed to report one or more tasks, one or more procedures, one or more services, and/or one or more actions performed by a provider for a patient related to a patient category. Additionally, the cumulative CPT map representation 404a may be configured as a vector representation (e.g., 1-D vector representation), an image (e.g., a visual embedding), a video (e.g., a video embedding), audio (e.g., an audio embedding), text, and/or another type of data representation to map presence of one or more CPT codes, map the number of occurrences of one or more CPT codes, and/or to map the predicted cost for the one or more CPT codes.

The cumulative DX map representation 404b may be a map representation that maps presence of one or more DX codes in medical records, a number of occurrences of one or more DX codes in medical records, and/or other data associated with categorical data for a patient category. The cumulative DX map representation 404b may additionally or alternatively map a predicted cost for the one or more DX codes with respect to presence and/or the number of occurrences for the one or more DX codes. A DX code may refer to a data construct that describes an identifier for a disease, disorder, symptom, poisoning, adverse medication effect, injury, or other diagnosis for a patient related to a patient category. In certain embodiments, a DX code may be a medical code employed to report a disease, disorder, symptom, poisoning, adverse medication effect, injury, or other diagnosis for a patient related to a patient category. Additionally, the cumulative DX map representation 404b may be configured as a vector representation (e.g., 1-D vector representation), an image (e.g., a visual embedding), a video (e.g., a video embedding), audio (e.g., an audio embedding), text, and/or another type of data representation to map the presence of one or more DX codes, map the number of occurrences of one or more DX codes, and/or to map the predicted cost for the one or more DX codes.

The cumulative RX map representation 404c may be a map representation that maps presence of one or more RX codes in medical records, a number of occurrences of one or more RX codes in medical records, and/or other data associated with categorical data for a patient category. The cumulative RX map representation 404c may additionally or alternatively map a predicted cost for the one or more RX codes with respect to presence and/or the number of occurrences for the one or more RX codes. An RX code may refer to a data construct that describes an identifier for a medication or prescription for a patient related to a patient category. In certain embodiments, an RX code may be a medical code employed to classify a medication or prescription for a patient related to a patient category. Additionally, the cumulative RX map representation 404c may be configured as a vector representation (e.g., 1-D vector representation), an image (e.g., a visual embedding), a video (e.g., a video embedding), audio (e.g., an audio embedding), text, and/or another type of data representation to map the presence of one or more RX codes, map the number of occurrences of one or more RX codes, and/or to map the predicted cost for the one or more RX codes.

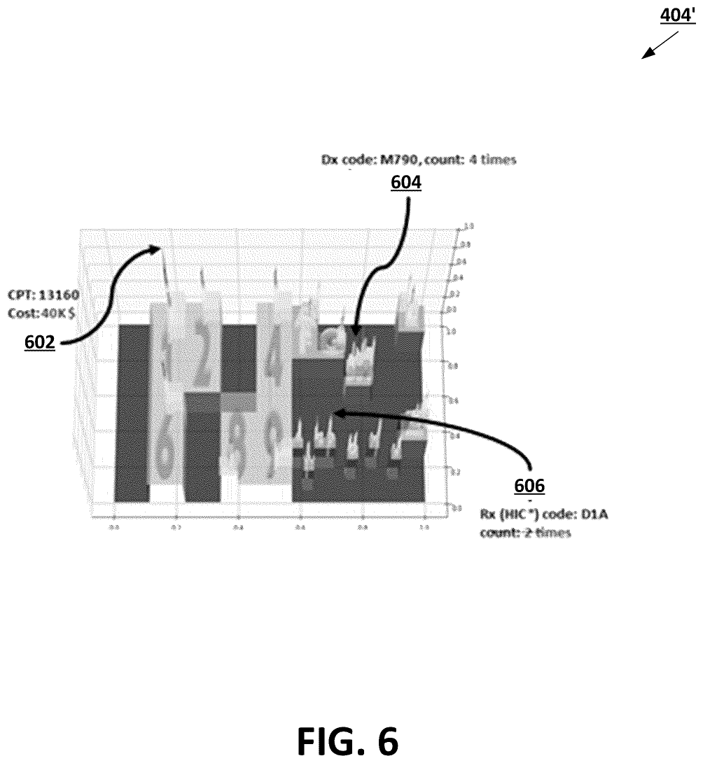

FIG. 6 illustrates another example first map representation 404′, in accordance with one or more embodiments of the present disclosure. As illustrated in FIG. 6, the first map representation 404′ is a visual embedding that maps presence of one or more predictive codes, a number of occurrences of one or more predictive codes, and/or a predicted cost for one or more predicted codes. In various embodiments, the first map representation 404′ may visually map one or more predictive codes and/or a predicted cost for one or more predicted codes using a three-dimensional representation of presence of one or more predictive codes, a number of occurrences of one or more predictive codes, and/or a predicted cost for one or more predicted codes. For example, the first map representation 404′ may include a predictive code 602 that visually maps a predicted cost (e.g., $40K) as indicated in categorical data for a particular task, procedure, service, and/or action performed by a provider for a patient related to a patient category. Additionally or alternatively, the first map representation 404′ may include a predictive code 604 that visually maps a number of occurrences (e.g., four occurrences) for a particular disease, disorder, symptom, poisoning, adverse medication effect, injury, or other diagnosis in categorical data for a patient related to a patient category. Additionally or alternatively, the first map representation 404′ may include a predictive code 606 that visually maps a number of occurrences (e.g., two occurrences) for a particular medication or prescription in categorical data for a patient related to a patient category.

Although the techniques described herein for generating image representations of categorical data are explained with reference to performing predictive data analysis, a person of ordinary skill in the relevant technology will recognize that the disclosed techniques have applications far beyond performing predictive data analysis. As an illustrative example, the disclosed techniques may be used in various data visualization applications. As another illustrative example, the disclosed techniques may be used to encode data in image-based data structures that facilitate at least one of data retrieval and data security. In some embodiments, the disclosed techniques may be used to generate video representations or other representations of categorical data, e.g., video representations that illustrate changes in the corresponding categorical data over time.

FIG. 7 illustrates an example system 700 related to multiple machine learning models associated with the data analytics engine 112, in accordance with one or more embodiments of the present disclosure. The system 700 includes a machine learning model 402a and a machine learning model 402b. In one or more embodiments, the data analytics engine 112 employs the machine learning model 402a and the machine learning model 402b to generate the prediction output 406. For example, the machine learning model 402a may be applied to the one or more first map representations 404 and the machine learning model 402b may be applied to the second map representation 405 to generate the prediction output 406.

In one or more embodiments, the machine learning model 402a is applied to the one or more first map representations 404 to generate a feature data vector 702 for categorical data associated with a patient category. Additionally, the machine learning model 402b may be applied to the second map representation 405 to generate a feature data vector 704 for categorical data associated with a provider category. Accordingly, in certain embodiments, the prediction output 406 may be generated based on the feature data vector 702 and the feature data vector 704. In one or more embodiments, the first feature data vector and the second feature data vector may be concatenated via a concatenation pipeline 706 that generates a concatenated feature data vector 705. The concatenated feature data vector 705 may be processed by one or more fully-connected layers 708a-n. The one or more fully-connected layers 708a-n may generate the prediction output 406 based on the concatenated feature data vector 705. In one or more embodiments, the one or more fully-connected layers 708a-n may generate a classification score for the concatenated feature data vector 705. Additionally, the prediction output 406 may be generated based on the classification score. In some embodiments, when the prediction output 406 may be a binary classification (e.g., classified as a “0” or “1”, or classified as a “positive diagnosis” or “a negative diagnosis” for a particular type of disease such as a particular type of rare disease, etc.).

Prediction-Based Actions and/or Visualizations

FIG. 8 illustrates an example system 800 for providing prediction-based actions and/or visualizations, in accordance with one or more embodiments of the present disclosure. The system 800 includes the prediction output 406 provided by the one or more machine learning models 402. In one or more embodiments, one or more prediction-based actions are performed based on the prediction output 406. For example, data associated with the prediction output 406 may be stored in a storage system, such as the storage subsystem 108 or another storage system associated with the classification prediction machine learning system 101. The data stored in the storage system may be employed for reporting, decision-making purposes, operations management, healthcare management, and/or other purposes. In certain embodiments, the data stored in the storage system may be employed to provide one or more insights to assist with healthcare decision making processes, such as, clinical decisions during a clinical review of medical records or for identifying certain types of medical conditions or diseases such as particular type of rare disease. Additionally or alternatively, the one or more machine learning models 402 may be retrained based on one or more features associated with the prediction output 406. For example, one or more relationships between features mapped in the one or more machine learning models 402 may be adjusted (e.g., refitted) based on data associated with the prediction output 406. In another example, cross-validation, hyperparameter optimization, and/or regularization associated with the one or more machine learning models 402 may be adjusted based on one or more features associated with the prediction output 406. Additionally or alternatively, a visualization 806 may be generated based on the prediction output 406. The visualization 806 may include, for example, one or more graphical elements for an electronic interface (e.g., an electronic interface of a user device) based on the prediction output 406.

It is to be appreciated that the prediction output 406 may additionally or alternatively be employed for a number of additional applications. For example, Clinical Decision Support (CDS), Clinical Decisions for Fraud (CDF), automatic claim creation, and/or efficient auditing of payment integrity clinical review decisions may be integrated into the visualization 806. Accordingly, the prediction output 406 may be employed to improve efficiency and/or reduce waste in an adjudication process related to medical records. The prediction output 406 may also assist clinical reviewers with review of medical records by presenting relevant pages, as calculated by the prediction output 406 for each claim line. In certain embodiments, the visualization 806 may include visual indicators (e.g., highlights) to indicate insights related to classification decisions (e.g., diagnosis decisions), as provided by the one or more machine learning models 402. Additionally or alternatively, the prediction output 406 may be employed to identify potential issues and/or certain content within medical records, thus reducing a number of computing resources. Furthermore, the prediction output 406 may additionally or alternatively be employed to identify particular types of decisions by leveraging predicted qualities for different predictive codes with respect to classification decisions. In some embodiments, the visualization 806 may provide a clinical decision support user interface tool related to improve clinical review of medical records.

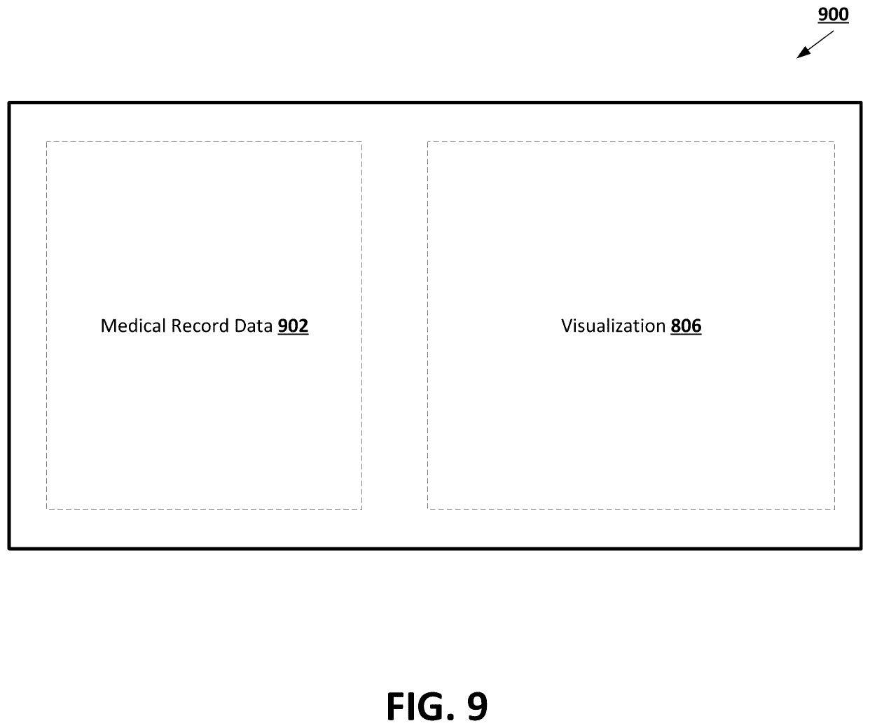

FIG. 9 illustrates an example user interface 900 for providing prediction-based visualizations, in accordance with one or more embodiments of the present disclosure. In one or more embodiments, the user interface 900 is, for example, an electronic interface (e.g., a graphical user interface) of the external computing entity 102. In various embodiments, the user interface 900 may be provided via the display 316 of the external computing entity 102. The user interface 900 may be configured to render the visualization 806. In various embodiments, the visualization 806 may provide a visualization of a prediction output (e.g., one or more classification predictions such as one or more diagnosis predictions) for medical records and/or categorical data related to a patient. For example, the visualization 806 may render one or more visual elements related to a prediction output (e.g., one or more classification predictions such as one or more diagnosis predictions) for medical records and/or categorical data related to a patient. Additionally, in certain embodiments, the user interface 900 may be configured to render medical record data 902 related to the visualization 806. The medical record data 902 may provide textual information and/or visual information related to medical records and/or categorical data related to a patient. In various embodiments, the user interface 900 may be configured as a user interface (e.g., a clinical decision support user interface, a disease diagnosis support user interface, etc.) for clinical decision automation related to medical records and/or categorical data related to a patient.

Another operational example of prediction-based actions that may be performed based on prediction outputs comprise performing operational load balancing for post-prediction systems that perform post-prediction operations (e.g., automated specialist appointment scheduling operations) based on prediction outputs. For example, in some embodiments, a predictive recommendation computing entity determines D classifications for D prediction input data objects based on whether the selected region subset for each prediction input data object as generated by the predictive recommendation model comprises a target region (e.g., a target brain region). Then, the count of D prediction input data objects that are associated with an affirmative classification, along with a resource utilization ratio for each prediction input data object, may be used to predict a predicted number of computing entities needed to perform post-prediction processing operations with respect to the D prediction input data objects. For example, in some embodiments, the number of computing entities needed to perform post-prediction processing operations (e.g., automated specialist scheduling operations) with respect to D prediction input data objects may be determined based on the output of the equation: R=ceil (Σₖ^{k=K} urₖ), where R is the predicted number of computing entities needed to perform post-prediction processing operations with respect to the D prediction input data objects, ceil (.) is a ceiling function that returns the closest integer that is greater than or equal to the value provided as the input parameter of the ceiling function, k is an index variable that iterates over K prediction input data objects among the D prediction input data objects that are associated with affirmative classifications, and urₖ is the estimated resource utilization ratio for a kth prediction input data object that may be determined based on a patient history complexity of a patient associated with the prediction input data object. In some embodiments, once R is generated, a predictive recommendation computing entity may use R to perform operational load balancing for a server system that is configured to perform post-prediction processing operations with respect to D prediction input data objects. This may be done by allocating computing entities to the post-prediction processing operations if the number of currently-allocated computing entities is below R, and deallocating currently-allocated computing entities if the number of currently-allocated computing entities is above R.

### Generating Prediction Output for Map Representations of Categorical Data Using Machine Learning

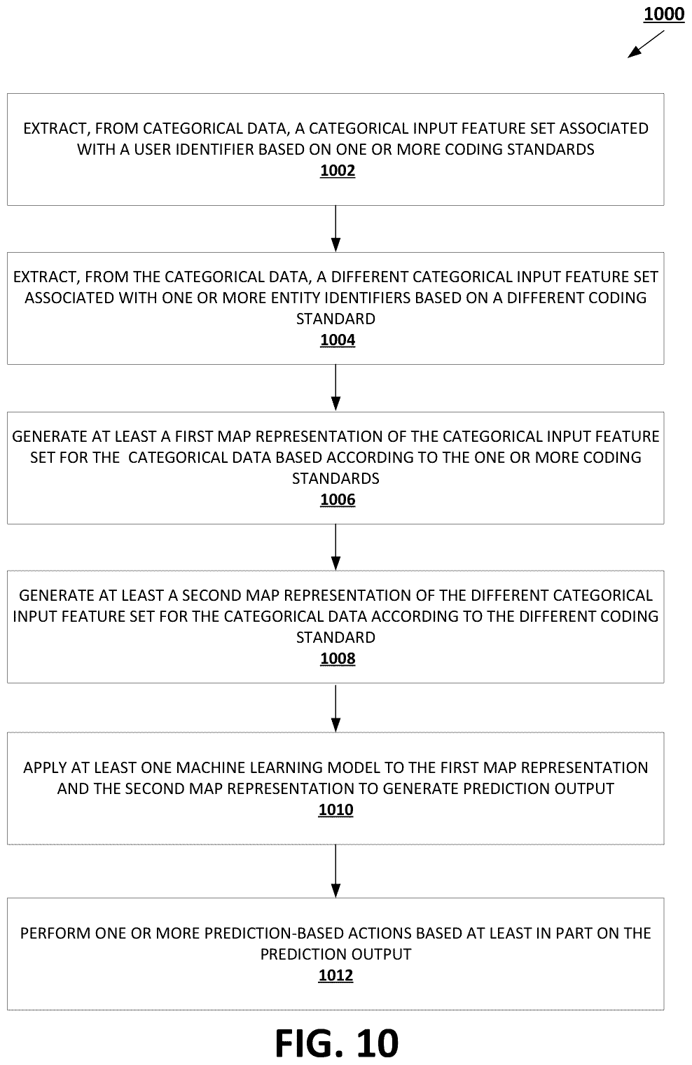

FIG. 10 is a flowchart diagram of an example process 1000 for generating a prediction output for categorical data using map representations of the categorical data, in accordance with one or more embodiments of the present disclosure. Via the various steps/operations of process 1000, the classification prediction machine learning computing entity 106 may process the map representation data 122 and/or other data using one or more artificial intelligence techniques (e.g., one or more machine learning techniques) to provide improved prediction output. In doing so, the classification prediction machine learning computing entity 106 may utilize machine learning solutions to infer important predictive insights and/or inferences related to data and/or features associated with map representations of categorical data.

The process 1000 begins at step/operation 1002 when the feature extraction engine 110 of the classification prediction machine learning computing entity 106 extracts, from categorical data, a categorical input feature set associated with a user identifier based on one or more coding standards. In some embodiments, the user identifier may be a patient identifier. The one or more coding standards may be encoding standards for classifying data. In some embodiments, the one or more coding standards may be a CPT coding standard, a DX coding standard, an RX coding standard, or another type of predictive coding standard related to a user identifier. In some embodiments, the categorical input feature set may be a clinical history feature set associated with the user identifier. In some embodiments, the categorical data may be an electronically-maintained data construct associated with one or more medical records and/or medical data.

At step/operation 1004, the feature extraction engine 110 of the classification prediction machine learning computing entity 106 extracts, from the categorical data, a different categorical input feature set associated with one or more entity identifiers based on a different coding standard. In some embodiments, an entity identifier may be a provider identifier. The different coding standard may be different than the one or more coding standards. Additionally, the different coding standard may be an encoding standard related to taxonomy for different types of entities. In some embodiments, the different coding standard may be a provider taxonomy code or another type of predictive coding standard related to an entity identifier. In some embodiments, the different categorical input feature set may be a provider history feature set associated with the one or more entity identifiers.

At step/operation 1006, the map representation engine 111 of the classification prediction machine learning computing entity 106 generates at least a first map representation of the categorical input feature set for the categorical data based according to the one or more coding standards. The first map representation may map presence of one or more predictive codes for the one or more coding standards in the categorical data. For example, the first map representation may map presence of a CPT code, a DX code, an RX code, a LONIC code, and/or or another type of predictive code in the categorical data. In some embodiments, the first map representation may map a number of occurrences in the categorical data for one or more predictive codes associated with the one or more coding standards. For example, the first map representation may map a number of occurrences of a CPT code, a DX code, an RX code, a LONIC code, and/or another type of predictive code in the categorical data. Additionally or alternatively, the first map representation may map a predicted cost for the one or more predictive codes associated with the one or more coding standards. In one or more embodiments, a portion (e.g., one or more pixels) of the first map representation associated with a particular predictive code may be modified based on presence of the particular code, a number of occurrences in the categorical data for the particular predictive code, and/or the predicted cost associated with the particular predictive code.

At step/operation 1008, the map representation engine 111 of the classification prediction machine learning computing entity 106 generates at least a second map representation of the different categorical input feature set for the categorical data according to the different coding standard. The second map representation may map presence of one or more predictive codes for the different coding standard in the categorical data. In some embodiments, the second map representation may map a number of occurrences in the categorical data for one or more predictive codes associated with the different coding standard. For example, the second map representation may map a number of occurrences of one or more provider taxonomy codes in the categorical data. Additionally or alternatively, the second map representation may map a predicted cost for the one or more predictive codes associated with the different coding standard. In one or more embodiments, a portion (e.g., one or more pixels) of the second map representation associated with a particular predictive code may be modified based on presence of the particular predictive code, a number of occurrences in the categorical data for the particular predictive code and/or the predicted cost associated with the particular predictive code.

At step/operation 1010, the data analytics engine 112 of the classification prediction machine learning computing entity 106 applies at least one machine learning model to the first map representation and the second map representation to generate the prediction output.

At step/operation 1012, the action engine 114 of the classification prediction machine learning computing entity 106 performs one or more prediction-based actions based on the prediction output. In certain embodiments, one or more graphical elements for an electronic interface are generated based on the prediction output. In certain embodiments, one or more machine learning models (e.g., the at least one machine learning model) may be retrained based on the prediction output.

In various embodiments, the step/operation 1002, the step/operation 1004, the step/operation 1006, the step/operation 1008, the step/operation 1010, and/or the step/operation 1012 may be repeated for each map representation and/or input.

Accordingly, as described above, various embodiments of the present disclosure address technical challenges related to accurately, efficiently, and/or reliably performing predictive data analysis of sparce data stored in disparate data sources. For example, in various embodiments, proposed solutions provide for modeling using machine learning with respect to map representations of the categorical data. In various embodiments, proposed solutions disclose classification predictions using machine learning. After the one or more machine learning models are generated, the one or more machine learning models may be utilized to perform accurate, efficient, and reliable classification predictions. Accordingly, techniques that improve predictive accuracy without harming training speed, such as various techniques described herein, enable improving training speed given a constant predictive accuracy. Therefore, by improving accuracy of performing machine learning predictions, various embodiments of the present disclosure improve the training speed of machine learning frameworks.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method for generating a prediction output for categorical data using map representations of the categorical data, the computer-implemented method comprising: generating, by one or more processors, at least a first map representation of a first categorical input feature set for categorical data based on a first coding standard, wherein the first map representation maps presence of one or more first predictive codes for the first coding standard in the categorical data; generating, by the one or more processors, at least a second map representation of a second categorical input feature set for the categorical data based on a second coding standard, wherein the second map representation maps presence of one or more second predictive codes for the second coding standard in the categorical data; generating, by the one or more processors and using at least one machine learning model, the prediction output based on the first map representation and the second map representation; and performing, by the one or more processors, one or more prediction-based actions based on the prediction output.

Example 2. The computer-implemented method of any of the preceding examples, wherein generating the first map representation comprises: configuring, by the one or more processors, the first map representation to map a first number of occurrences in the categorical data for the one or more first predictive codes.

Example 3. The computer-implemented method of any of the preceding examples, wherein generating the first map representation comprises: configuring, by the one or more processors, the first map representation to map a predicted cost for the one or more first predictive codes with respect to the first number of occurrences.

Example 4. The computer-implemented method of any of the preceding examples, wherein generating the second map representation comprises: configuring, by the one or more processors, the second map representation to map a second number of occurrences in the categorical data for the one or more second predictive codes.

Example 5. The computer-implemented method of any of the preceding examples, wherein generating the second map representation comprises: configuring, by the one or more processors, the second map representation to map a predicted cost for the one or more second predictive codes with respect to the second number of occurrences.

Example 6. The computer-implemented method of any of the preceding examples, further comprising configuring, by the one or more processors, the first map representation as a first visual embedding that visually maps the presence of the one or more first predictive codes in the categorical data.

Example 7. The computer-implemented method of any of the preceding examples, further comprising configuring, by the one or more processors, the second map representation as a second visual embedding that visually maps the presence of the one or more second predictive codes in the categorical data.

Example 8. The computer-implemented method of any of the preceding examples, wherein generating the prediction output comprises: generating, by the one or more processors and using a first machine learning model, a first feature data vector for the categorical data based on the first map representation.

Example 9. The computer-implemented method of any of the preceding examples, wherein generating the prediction output comprises: generating, by the one or more processors and using a second machine learning model, a second feature data vector for the categorical data based on the second map representation.

Example 10. The computer-implemented method of any of the preceding examples, further comprising: generating, by the one or more processors, the prediction output based on the first feature data vector and the second feature data vector.

Example 11. The computer-implemented method of any of the preceding examples, further comprising: concatenating, by the one or more processors, the first feature data vector and the second feature data vector to generate a concatenated feature data vector.

Example 12. The computer-implemented method of any of the preceding examples, further comprising: generating, by the one or more processors, a classification score for the concatenated feature data vector.

Example 13. The computer-implemented method of any of the preceding examples, further comprising: generating, by the one or more processors, the prediction output based on the classification score.

Example 14. A computing apparatus comprising memory and one or more processors communicatively coupled to the memory, the one or more processors configured to generate at least a first map representation of a first categorical input feature set for categorical data based on a first coding standard, wherein the first map representation maps presence of one or more first predictive codes for the first coding standard in the categorical data; generate at least a second map representation of a second categorical input feature set for the categorical data based on a second coding standard, wherein the second map representation maps presence of one or more second predictive codes for the second coding standard in the categorical data; generate, using at least one machine learning model, a prediction output based on the first map representation and the second map representation; and initiate the performance of one or more prediction-based actions based on the prediction output.

Example 15. The computing apparatus of any of the preceding examples, wherein the one or more processors are further configured to: configure the first map representation to map (i) first number of occurrences in the categorical data for the one or more first predictive codes and/or (ii) a predicted cost for the one or more first predictive codes with respect to the first number of occurrences.

Example 16. The computing apparatus of any of the preceding examples, wherein the one or more processors are further configured to: configure the second map representation to map (i) a second number of occurrences in the categorical data for the one or more second predictive codes and/or (ii) a predicted cost for the one or more second predictive codes with respect to the second number of occurrences.

Example 17. The computing apparatus of any of the preceding examples, wherein the one or more processors are further configured to: configure the first map representation as a first visual embedding that visually maps the presence of the one or more first predictive codes in the categorical data; and configure the second map representation as a second visual embedding that visually maps the presence of the one or more second predictive codes in the categorical data.

Example 18. The computing apparatus of any of the preceding examples, wherein the one or more processors are further configured to: generate, using a first machine learning model, a first feature data vector for the categorical data based on the first map representation; and generate, using a second machine learning model, a second feature data vector for the categorical data based on the second map representation.

Example 19. The computing apparatus of any of the preceding examples, wherein the one or more processors are further configured to: generate the prediction output based on the first feature data vector and the second feature data vector.

Example 20. The computing apparatus of any of the preceding examples, wherein the one or more processors are further configured to: concatenate the first feature data vector and the second feature data vector to generate a concatenated feature data vector; generate a classification score for the concatenated feature data vector; and generate the prediction output based on the classification score.

Example 21. One or more non-transitory computer-readable storage media including instructions that, when executed by one or more processors, cause the one or more processors to: generate at least a first map representation of a first categorical input feature set for categorical data based on a first coding standard, wherein the first map representation maps presence of one or more first predictive codes for the first coding standard in the categorical data; generate at least a second map representation of a second categorical input feature set for the categorical data based on a second coding standard, wherein the second map representation maps presence of one or more second predictive codes for the second coding standard in the categorical data; generate, using at least one machine learning model, a prediction output based on the first map representation and the second map representation; and initiate the performance of one or more prediction-based actions based on the prediction output.

Example 22. The non-transitory computer-readable storage media of any of the preceding examples, wherein the instructions further cause the one or more processors to: configure the first map representation to map (i) first number of occurrences in the categorical data for the one or more first predictive codes and/or (ii) a predicted cost for the one or more first predictive codes with respect to the first number of occurrences.

Example 23. The non-transitory computer-readable storage media of any of the preceding examples, wherein the instructions further cause the one or more processors to: configure the second map representation to map (i) a second number of occurrences in the categorical data for the one or more second predictive codes and/or (ii) a predicted cost for the one or more second predictive codes with respect to the second number of occurrences.

Example 24. The non-transitory computer-readable storage media of any of the preceding examples, wherein the instructions further cause the one or more processors to: configure the first map representation as a first visual embedding that visually maps the presence of the one or more first predictive codes in the categorical data; and configure the second map representation as a second visual embedding that visually maps the presence of the one or more second predictive codes in the categorical data.

1. A computer-implemented method for generating a prediction output for categorical data using map representations of the categorical data, the computer-implemented method comprising:
generating, by one or more processors, at least a first map representation of a first categorical input feature set for categorical data based on a first coding standard, wherein the first map representation maps presence of one or more first predictive codes for the first coding standard in the categorical data;
generating, by the one or more processors, at least a second map representation of a second categorical input feature set for the categorical data based on a second coding standard, wherein the second map representation maps presence of one or more second predictive codes for the second coding standard in the categorical data;
generating, by the one or more processors and using at least one machine learning model, a prediction output based on the first map representation and the second map representation; and
initiating, by the one or more processors, the performance of one or more prediction-based actions based on the prediction output.

2. The computer-implemented method of claim 1, wherein generating the first map representation comprises:
configuring, by the one or more processors, the first map representation to map a first number of occurrences in the categorical data for the one or more first predictive codes.

3. The computer-implemented method of claim 1, wherein generating the first map representation comprises:
configuring, by the one or more processors, the first map representation to map a predicted cost for the one or more first predictive codes with respect to the first number of occurrences.

4. The computer-implemented method of claim 1, wherein generating the second map representation comprises:
configuring, by the one or more processors, the second map representation to map a second number of occurrences in the categorical data for the one or more second predictive codes.

5. The computer-implemented method of claim 1, wherein generating the second map representation comprises:
configuring, by the one or more processors, the second map representation to map a predicted cost for the one or more second predictive codes with respect to the second number of occurrences.

6. The computer-implemented method of claim 1, further comprising:
configuring, by the one or more processors, the first map representation as a first visual embedding that visually maps the presence of the one or more first predictive codes in the categorical data; and
configuring, by the one or more processors, the second map representation as a second visual embedding that visually maps the presence of the one or more second predictive codes in the categorical data.

7. The computer-implemented method of claim 1, wherein generating the predicted output comprises:
generating, by the one or more processors and using a first machine learning model, a first feature data vector for the categorical data based on the first map representation; and
generating, by the one or more processors and using a second machine learning model, a second feature data vector for the categorical data based on the second map representation.

8. The computer-implemented method of claim 5, further comprising:
generating, by the one or more processors, the prediction output based on the first feature data vector and the second feature data vector.

9. The computer-implemented method of claim 5, further comprising:
concatenating, by the one or more processors, the first feature data vector and the second feature data vector to generate a concatenated feature data vector;
generating, by the one or more processors, a classification score for the concatenated feature data vector; and
generating, by the one or more processors, the prediction output based on the classification score.

10. A computing apparatus comprising memory and one or more processors communicatively coupled to the memory, the one or more processors configured to:
generate at least a first map representation of a first categorical input feature set for categorical data based on a first coding standard, wherein the first map representation maps presence of one or more first predictive codes for the first coding standard in the categorical data;
generate at least a second map representation of a second categorical input feature set for the categorical data based on a second coding standard, wherein the second map representation maps presence of one or more second predictive codes for the second coding standard in the categorical data;
generate, using at least one machine learning model, a prediction output based on the first map representation and the second map representation; and
initiate the performance of one or more prediction-based actions based on the prediction output.

11. The computing apparatus of claim 8, wherein the one or more processors are further configured to:
configure the first map representation to map at least one of (i) first number of occurrences in the categorical data for the one or more first predictive codes and (ii) a predicted cost for the one or more first predictive codes with respect to the first number of occurrences.

12. The computing apparatus of claim 8, wherein the one or more processors are further configured to:
configure the second map representation to map at least one of (i) a second number of occurrences in the categorical data for the one or more second predictive codes and (ii) a predicted cost for the one or more second predictive codes with respect to the second number of occurrences.

13. The computing apparatus of claim 8, wherein the one or more processors are further configured to:
configure the first map representation as a first visual embedding that visually maps the presence of the one or more first predictive codes in the categorical data; and
configure the second map representation as a second visual embedding that visually maps the presence of the one or more second predictive codes in the categorical data.

14. The computing apparatus of claim 8, wherein the one or more processors are further configured to:
generate, using a first machine learning model, a first feature data vector for the categorical data based on the first map representation; and
generate, using a second machine learning model, a second feature data vector for the categorical data based on the second map representation.

15. The computing apparatus of claim 12, wherein the one or more processors are further configured to:
generate the prediction output based on the first feature data vector and the second feature data vector.

16. The computing apparatus of claim 12, wherein the one or more processors are further configured to:
concatenate the first feature data vector and the second feature data vector to generate a concatenated feature data vector;
generate a classification score for the concatenated feature data vector; and
generate the prediction output based on the classification score.

17. One or more non-transitory computer-readable storage media including instructions that, when executed by one or more processors, cause the one or more processors to:
generate at least a first map representation of a first categorical input feature set for categorical data based on a first coding standard, wherein the first map representation maps presence of one or more first predictive codes for the first coding standard in the categorical data;
generate at least a second map representation of a second categorical input feature set for the categorical data based on a second coding standard, wherein the second map representation maps presence of one or more second predictive codes for the second coding standard in the categorical data;
generate, using at least one machine learning model, a prediction output based on the first map representation and the second map representation; and
initiate the performance of one or more prediction-based actions based on the prediction output.

18. The one or more non-transitory computer-readable storage media of claim 17, wherein the instructions further cause the one or more processors to:
configure the first map representation to map at least one of (i) first number of occurrences in the categorical data for the one or more first predictive codes and (ii) a predicted cost for the one or more first predictive codes with respect to the first number of occurrences.

19. The one or more non-transitory computer-readable storage media of claim 17, wherein the instructions further cause the one or more processors to:
configure the second map representation to map at least one of (i) a second number of occurrences in the categorical data for the one or more second predictive codes and (ii) a predicted cost for the one or more second predictive codes with respect to the second number of occurrences.

20. The one or more non-transitory computer-readable storage media of claim 17, wherein the instructions further cause the one or more processors to:
configure the first map representation as a first visual embedding that visually maps the presence of the one or more first predictive codes in the categorical data; and
configure the second map representation as a second visual embedding that visually maps the presence of the one or more second predictive codes in the categorical data.
